(19) United States
(12) Patent Application Publication
(10) Pub. No.: US 2010/0164741 A1
(43) Pub. Date: Jul. 1, 2010

(54) Wireless music transmission device for wirelessly controlling volume-adjustment and song-selection functions of ipod

(75) Inventors: Shi Chang Hsu, Taipei (TW); Chih Ming Wu, Taipei (TW)

Correspondence Address: BACON & THOMAS, PLLC, 625 SLATERS LANE, FOURTH FLOOR, ALEXANDRIA, VA, 22314-1176, US

(73) Assignee: Tatung Company, Taipei (TW)

(21) Appl. No.: 12/382,207

(22) Filed: Mar. 11, 2009

(30) Foreign Application Priority Data
Dec. 26, 2008 (TW) 097223388

(51) Int. Cl. G05B 19/02

(52) U.S. Cl. 340/825.24

(57) ABSTRACT

A wireless music transmission device for wirelessly controlling volume-adjustment and song-selection functions of iPod includes a wireless earphone and a wireless music transmitter. The wireless music transmitter is electrically connected to iPod. The wireless earphone and the wireless music transmitter both have a radio frequency integrated circuit, so as to transmit control signals of volume-adjustment and song-selection functions between wireless earphone and wireless music transmitter via radio frequency integrated circuits.

### BACKGROUND OF THE INVENTION

1. Field of the Invention

The invention relates generally to a wireless music transmission device and, more particularly, to a wireless music transmission device for wirelessly controlling volume-adjustment and song-selection functions of iPod.

2. Description of Related Art

FIG. 1 shows a known wireless earphone for use with a multimedia device such as iPod and MP3 player. The wireless earphone is able to adjust the speaker volume via operating a volume control knob 10. Typically, the wireless earphone is not provided to control output volume of iPod directly, resulting in constraining the output volume range of iPod. Furthermore, the typical wireless earphone does not provide the song-selection function that is frequently used in iPod playing. Users can only select songs via iPod itself. Therefore, it is desirable to provide an improved wireless music transmission device for users to easily control the volume-adjustment and song-selection functions of iPod.

### SUMMARY OF THE INVENTION

The object of the present invention is to provide a wireless music transmission device for wirelessly controlling volume-adjustment and song-selection functions of iPod.

To achieve this object, there is provided a wireless music transmission device for wirelessly controlling volume-adjustment and song-selection functions of iPod, comprising: a wireless earphone, including a speaker unit, a volume-adjustment and song-selection unit, and a first radio frequency integrated circuit, the first radio frequency integrated circuit being electrically connected to the speaker unit and the volume-adjustment and song-selection unit; and a wireless music transmitter, including a second radio frequency integrated circuit, a microprocessor, an analog/digital converter and a connection interface, the second radio frequency integrated circuit being electrically connected to the microprocessor and the analog/digital converter and wirelessly coupled to the first radio frequency integrated circuit, the wireless music transmitter being electrically connected to iPod through the connection interface, so as to control the volume-adjustment and song-selection functions of iPod via the wireless music transmitter and the wireless earphone.

### BRIEF DESCRIPTION OF THE DRAWINGS

FIG. 1 shows a conventional wireless earphone for adjusting speaker volume via a volume control knob;

FIG. 2 schematically illustrates a wireless music transmission device in accordance with the present invention;

FIG. 3 shows an internal circuit arrangement of the wireless earphone in accordance with the present invention; and

FIG. 4 shows an internal circuit arrangement of the wireless music transmitter in accordance with the present invention.

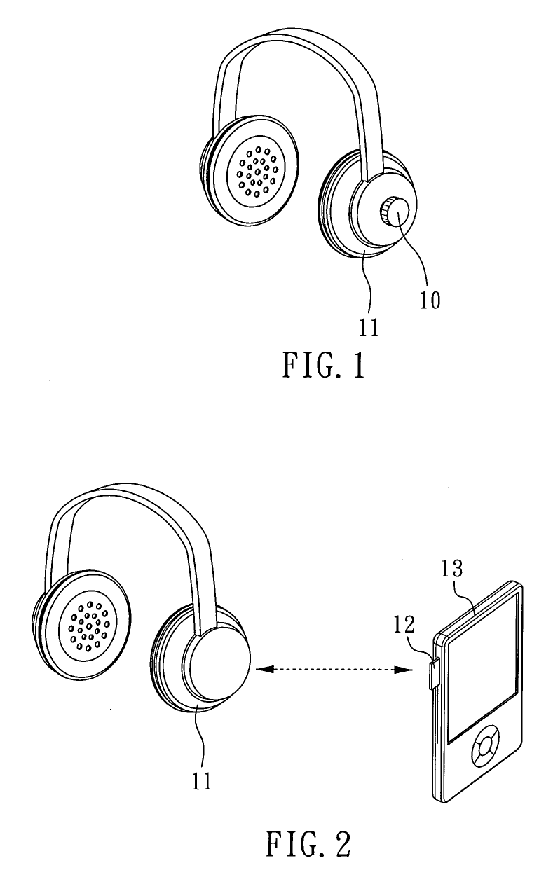

### DETAILED DESCRIPTION OF THE PREFERRED EMBODIMENT

With reference to FIG. 2, there is shown a wireless music transmission device for wirelessly controlling volume-adjustment and song-selection functions of iPod in accordance with the present invention, which includes: a wireless earphone 11, a wireless music transmitter 12 and an iPod 13. The wireless earphone 11 transmits control signals for adjusting volume and selecting song in radio form to the wireless music transmitter 12. The wireless music transmitter 12 is electrically connected to the iPod 13, so as to transmit the control signals received from the wireless earphone 11 to the iPod 13 for controlling the volume-adjustment and song-selection functions. Meanwhile, the iPod 13 transmits digital audio signals to the wireless earphone 11 via the wireless music transmitter 12 for playing.

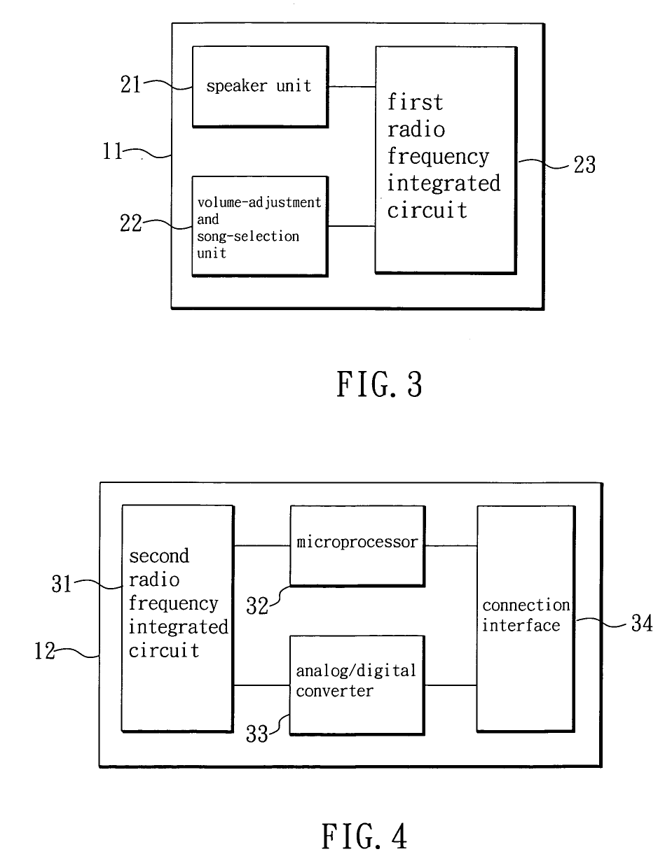

FIG. 3 shows an internal circuit arrangement of the wireless earphone 11, which includes a speaker unit 21, a volume-adjustment and song-selection unit 22, and a first radio frequency integrated circuit 23. The first radio frequency integrated circuit 23 is electrically connected to the speaker unit 21 and the volume-adjustment and song-selection unit 22. Users may operate a control button, not shown, on the wireless earphone 11 to input the control signals for adjusting volume and selecting song to the volume-adjustment and song-selection unit 22 which is electrically connected to the first radio frequency integrated circuit 23. The first radio frequency integrated circuit 23 transmits the control signals in radio form to the wireless music transmitter 12.

FIG. 4 shows an internal circuit arrangement of the wireless music transmitter 12, which includes a second radio frequency integrated circuit 31, a microprocessor 32, an analog/digital converter 33 and a connection interface 34. The second radio frequency integrated circuit 31 is electrically connected to the microprocessor 32 and the analog/digital converter 33, and is wirelessly coupled to the first radio frequency integrated circuit 23 of the wireless earphone 11. The second radio frequency integrated circuit 31 of the wireless music transmitter 12 transmits the control signals received from the first radio frequency integrated circuit 23 of the wireless earphone 11 to the microprocessor 32. The microprocessor 32 transmits the control signals to the iPod 13 via the connection interface 34 for executing the volume-adjustment and song-selection functions. Meanwhile, the analog/digital converter 33 of the wireless music transmitter 12 transforms analog audio signals received from the iPod 13 into digital audio signals and transmits digital audio signals to the first radio frequency integrated circuit 23 of the wireless earphone 11 via the second radio frequency integrated circuit 31. The first radio frequency integrated circuit 23 of the wireless earphone 11 transforms digital audio signals received from the second radio frequency integrated circuit 31 of the wireless music transmitter 12 into analog audio signals and transmits the analog audio signals to the speaker unit 21 for playing.

In view of the foregoing, it is known that the present invention provides the wireless music transmission device to transmit radio frequency signals between the wireless earphone 11 and the wireless music transmitter 12, so as to enable users to easily listen music and control iPod 13 without the inconvenience of using an earphone wire.

Although the present invention has been explained in relation to its preferred embodiment, it is to be understood that many other possible modifications and variations can be made without departing from the spirit and scope of the invention as hereinafter claimed.

What is claimed is:

1. A wireless music transmission device for wirelessly controlling volume-adjustment and song-selection functions of iPod, comprising:
a wireless earphone, including a speaker unit, a volume-adjustment and song-selection unit, and a first radio frequency integrated circuit, the first radio frequency integrated circuit being electrically connected to the speaker unit and the volume-adjustment and song-selection unit; and
a wireless music transmitter, including a second radio frequency integrated circuit, a microprocessor, an analog/digital converter and a connection interface, the second radio frequency integrated circuit being electrically connected to the microprocessor and the analog/digital converter and wirelessly coupled to the first radio frequency integrated circuit, the wireless music transmitter being electrically connected to i-Pod through the connection interface, so as to control the volume-adjustment and song-selection functions of iPod via the wireless music transmitter and the wireless earphone.

2. The wireless music transmission device of claim 1, wherein the first radio frequency integrated circuit of the wireless earphone transmits control signals in radio form to the second radio frequency integrated circuit of the wireless music transmitter.

3. The wireless music transmission device of claim 2, wherein the control signals are provided to select songs and adjust volume.

4. The wireless music transmission device of claim 2, wherein the first radio frequency integrated circuit of the wireless earphone transforms digital audio signals received from the second radio frequency integrated circuit of the wireless music transmitter into analog audio signals and transmits the analog audio signals to the speaker unit for playing.

5. The wireless music transmission device of claim 1, wherein the second radio frequency integrated circuit of the wireless music transmitter transmits control signals received from the first radio frequency integrated circuit of the wireless earphone to the microprocessor for controlling the volume-adjustment and song-selection functions of iPod through the connection interface.

6. The wireless music transmission device of claim 5, wherein the control signals are provided to select songs and adjust volume.

7. The wireless music transmission device of claim 5, wherein the analog/digital converter of the wireless music transmitter transforms analog audio signals received from iPod into digital audio signals and transmits digital audio signals to the first radio frequency integrated circuit of the wireless earphone through the second radio frequency integrated circuit.

8. The wireless music transmission device of claim 1, wherein the connection interface is an Universal Asynchronous Receiver/Transmitter interface.
